(19) United States
(12) Patent Application Publication
(10) Pub. No.: US 2006/0098153 A1
(43) Pub. Date: May 11, 2006

(54) Method of manufacturing a curved display

(76) Inventors: Peter J Slikkerveer, Eindhoven (NL); Petrus Cornelis Paulus Bouten, Eindhoven (NL); Peter Albert Cirkel, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/535,753

(22) PCT Filed: Oct. 29, 2003
(86) PCT No.: PCT/IB03/04888

§ 371 Date: May 19, 2005

(30) Foreign Application Priority Data
Nov. 22, 2002 (EP) 02079945.8

(51) Int. Cl. G02F 1/13; B29C 65/00; B29C 51/16

(52) U.S. Cl. 349/187; 156/196; 156/212

(57) ABSTRACT

This invention relates to a method of manufacturing a curved flat panel display device, comprising the step of adhering, at least a first film (1, 11) to the surface of a second film (2, 12), in such a way that the films (1, 11; 2, 12) are held in a curved shape by means of the adhesion between the films (1, 11; 2, 12). The invention also relates to a curved flat panel display device, comprising at least a first and a second film, characterised in that the first and second films are adhered to each other, whereby the adhesion between said films is arranged to hold the display device in a curved shape.

This invention relates to a method of manufacturing a curved display device. The invention also relates to a curved display device.

There is today a fast growing market for different types of flat displays, such as liquid crystal displays, polymer light emitting displays, organic light emitting displays and so on, and the number of applications for such displays are constantly growing. Many of these display types have a common structure, and essentially comprise two substrates, commonly of a glass or polymer-based material, and a layer of optically controllable material, arranged between the substrates. As an alternative, the display may be built on a single substrate. Moreover, the above-mentioned layer of optically controllable material may for example be a liquid crystal layer or a light emissive layer. Also, the display usually comprises some type of electrode means in order to control the optically controllable material.

In certain application fields, such as mobile applications, advertising and so on, there is an increasing demand of flexible displays, which may for example be rolled up in order to require less space, or bendable displays. However, a problem with the display types described above is that they, due to the substrates and in some cases also the electrodes, are quite rigid and exhibit a low tolerance for bending stresses. Hence, the flexibility and bendability is limited by the materials of the display device.

One prior art method of manufacturing a bended display, in the present case a liquid crystal display, is disclosed in the patent application document WO 94/11779. This application is concerned with a method for manufacturing a curved display by sandwiching a liquid crystal cell between two pre-shaped curved substrates. However, a problem with this method is that it is practically very difficult as well as expensive to maintain a homogeneous cell gap between the two pre-shaped substrates, which affects the optical properties of the display device. Moreover, a separate shaping tool must be manufactured for each product that is to be produced, in order to provide different curvatures of the display device. Hence, the above method is not suitable for mass-production of display devices. Moreover, pre-shaped parts, as is used in the above method, requires either some thickness or a three-dimensional shape, such as a double curved shape, in order to keep its shape. This is undesirable since this either adds thickness to the display or requires a more complicated production process. An alternative way of manufacturing a curved display is discussed in the same document as referred to above. According to this method, a curved display is achieved by manufacturing a display using two flexible substrates, between which a liquid crystal layer is sandwiched. Subsequently the display is curved by placing flexible device, being constituted by the flexible substrates, as well as the liquid crystal layer, between two pre-shaped parts. Even if this alternative method overcome the problem with the homogenous cell gap discussed above, it still exhibits several of the other drawbacks mentioned above, such as the need for separate shaping tools. An alternative way of manufacturing curved displays is therefore desired.

Hence, an object of this invention is to overcome at least some of the drawbacks with the prior art mentioned above, and to provide a display that may be manufactured in a comparatively cost-efficient and flexible manner.

This and other objects are at least partly achieved a method of manufacturing a curved flat panel display, comprising the step of adhering, at least a first film to the surface of a second film, in such a way that the films are held in a curved shape by means of the adhesion between the films. By the invention, an easy and straightforward method of manufacturing a curved display is achieved. By letting the adhesion itself keep a display in a curved state, pre-shaping of parts is not necessary, thereby avoiding some of the drawbacks with the prior art mentioned above.

Preferably, one of said films is a display layer exhibiting display functionality, and the other one of said films is an additional film. Thereby, a curved display may in principle be formed by manufacturing a flat panel display on per se known manner, and thereafter curve the display by adhering an additional film to it. It shall be noted that the term “display layer” as used here in shall be understood as a layer containing an electro-optical layer, which may be controlled so as to provide display functionality, such as picture and/or text reproduction.

According to a first preferred embodiment of the invention the method further comprises the step of pre-tensioning said additional film before it is adhered to the surface of said display layer. By thereafter releasing a pretension force from the additional film, the contraction of the additional film will cause a curving of the display device in a simple and straight-forward manner. As an alternative, the step of pre-tensioning said additional film comprises the step of uni-axially stretching said additional film, during the adhering process. Thereby, curving of the display in one dimension is achieved.

According to a second preferred embodiment of this invention, the step of adhering the films to each other comprises the step of applying a bending force to one of said films, in which position the other film is bent and adhered to a surface of the bent film. Preferably, said additional film is arranged to be adhered to one of an intended inner or outer side of the curvature of the flat panel display, in order to shift a neutral line of the display into the additional film, whereby sensitive parts of the display layer is positioned in or close to a compression zone.

Preferably, said adhering of the additional film to the display layer is done by means of laminating, being a suitable and straight-forward adhesion method for this purpose.

The above and other objects are also at least partly achieved by a curved flat panel display device, comprising a first and a second film, being characterised in that the first and second films are adhered to each other, whereby the adhesion between said films is arranged to hold the display device in a curved shape, having the same advantages as mentioned above. Suitably, the first and second film is an additional film and a display layer, respectively.

According to a first preferred embodiment of the invention, said additional film is arranged to cover essentially the entire surface of the display layer, giving a mechanical support to the entire display. Alternatively, wherein said additional film is arranged to only partly cover parts of the surface of the display layer, whereby the neutral line for the display may be shifted for parts of the display, for example comprising brittle parts. For example, said additional film is arranged essentially along an edge of the display layer surface. In order to further customise the mechanical behaviour and the neutral line of the display, the additional film may have a varying thickness.

Preferably, the thickness of said additional film is selected to shift a plane of essentially zero tensile or compressive stress of the display device upon bending of the display device to a desired plane of the display device cross section.

Suitably, said display device is one of an liquid crystal display device, an electrophoretic display device, an e-ink device, a polymer light emitting display device or an organic light emitting display device. However, the invention may be used with any flat panel display device technology, exhibiting the desired flexibility. Moreover, said additional layerfilm may further be arranged to function as at least one of polariser, a front light, a backlight, a brightness enhancing film, a reflector film, an anti-reflection film or a retardation film. Thereby, by letting the additional film be an active part of the functionality of the display layer, the total thickness of the display device may be reduced.

Other advantages and embodiments of this invention are apparent from the description below.

The invention will hereinafter be described by means of preferred embodiments thereof, with reference to the accompanying drawings.

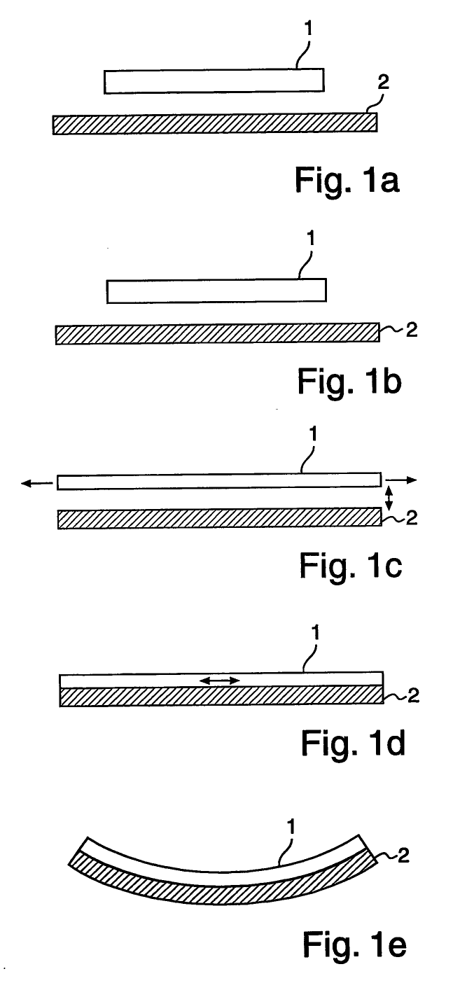

FIG. 1a-1e illustrates cross section views of the manufacturing of a curved flat panel display device according to a first embodiment of the invention.

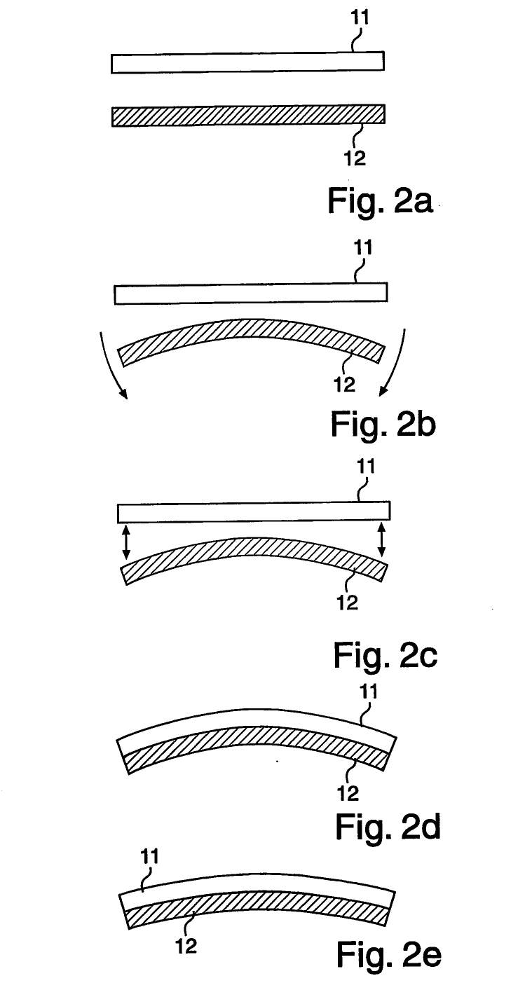

FIG. 2a-2e illustrates cross section views of the manufacturing of a curved flat panel display device according to a second embodiment of the invention.

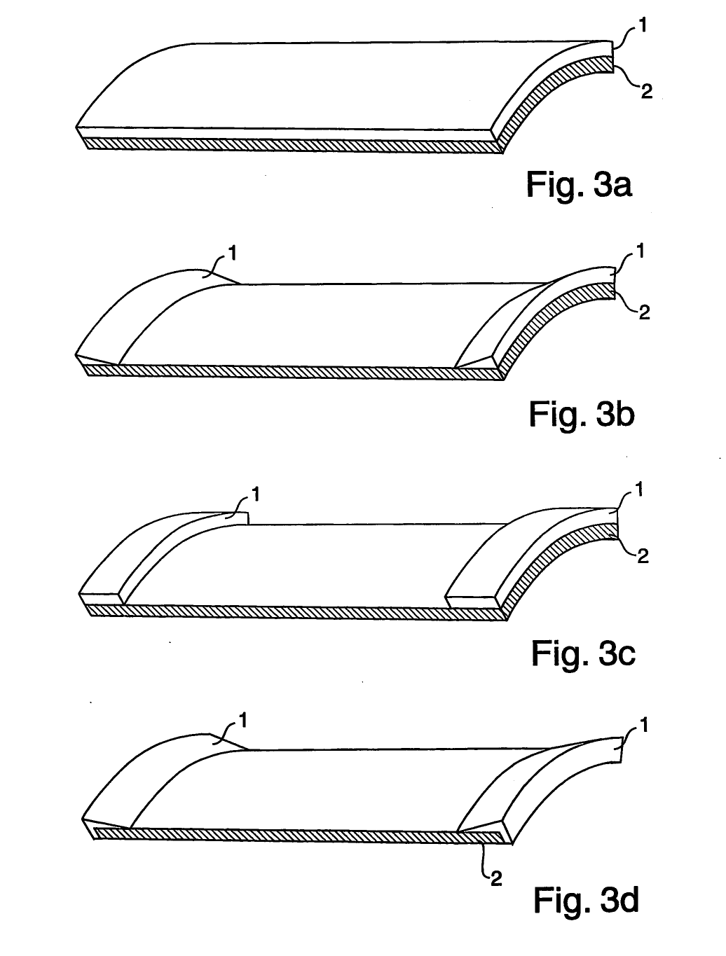

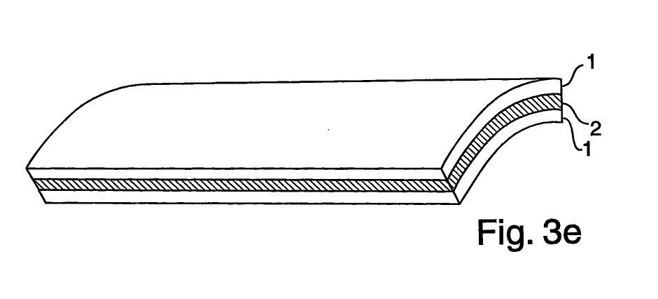

FIG. 3a-3e illustrate cross section views of five different application patterns for the additional film or the additional films according to this invention.

A first preferred embodiment of the present invention will hereinafter be described with reference to FIG. 1a-1e. In accordance with the inventive method for manufacturing a curved display illustrated by FIG. 1a-1e a first and a second film to be adhered together in order to form the display are provided. The first film is in the case disclosed in FIG. 1a-1e an additional film 1, according to the invention, while the second film in this case is a display layer 2, comprising display functionality. Both the additional film 1 and the display layer 2 will be described in closer detail below. The inventive method for manufacturing the curved display comprises in this embodiment the following steps. First, the additional film 1 and the display layer 2 are provided (FIG. 1a). Subsequently, one of the films, here the additional film 1 is uni-axially stretched (FIG. 1b). Thereafter the uni-axially stretched additional film 1 and the display layer 2 are joined together and adhered to each other (FIG. 1c and FIG. 1d). This adhesion may for example be performed by a lamination process between the additional film and the display layer. For example, the adhesion between the layers may be made by means of a pressure-sensitive adhesive. However, if a more form-stable construction is desired, the adhesion may for example be made by means of a reactive glue or the like. In this adhered state, as disclosed in FIG. 1d, the pre-stretching of the additional film 1 will result in a corresponding contraction of the additional film 1, as the pre-stretching force is released. Due to the adhesion of the display layer 2 and the additional film 1, this contraction results in a bending of the display, as is disclosed in FIG. 1e, and as long as the resulting display is not under influence of a force, this bending will remain unchanged. Hence, the display may be said to be constituted by two films, or originally un-curved layers, being held in a curved shape by means of the adhesion between the films.

As will be understood, the above method facilitates easy adjustment of the curvature of the resulting display, in order to fit the display for various applications. By providing different amounts of pre-stretching to the additional film 1, different curvature of the resulting display is achieved. Moreover, it is possible to provide the additional film 1 with a pre-stretching being uneven over the surface of the film, which after adhesion results in a display having a varying curvature, in order to further customise the fit of the display. Moreover, this flexible shaping of the display may be done without using special moulds or the like, which facilitates manufacturing of the inventive display.

A second preferred embodiment of the present invention will hereinafter be described with reference to FIG. 2a-2d. In accordance with the method for manufacturing a curved display illustrated by FIG. 2a-2d a first and a second film to be adhered together in order to form the display are provided. The first film is in the case disclosed in FIG. 2a-2d, an additional film 11, according to the invention, while the second film in this case is a display layer 12, comprising display functionality. It shall however be noted that in this embodiment, the functions of the respective films may be interchanged. Both the additional film 11 and the display layer 12 will be described in closer detail below. The inventive method for manufacturing the curved display, comprises in this embodiment the following steps. First the additional film 11 and the display layer 12 is provided (FIG. 2a). One of the films, in the illustrated case the display layer 12, is subjected to a bending force, by means of force application means (not shown) (FIG. 2b). While said bending force is applied to the display layer 12, the additional film 11 and the display layer 12 are joined together and adhered to each other (FIG. 2c and FIG. 2d), whereafter the force applied to the display layer 12 may be released. The above adhesion may for example be performed by a lamination process between the additional film and the display layer. As is seen in FIGS. 2c and 2d, the film is applied on the outer curvature surface of the film that is subjected to the bending force. Due to the adhesion of the display layer 12 and the additional film 11, the above process results in a bended display, as is disclosed in FIG. 2d. However, when the bending force is released from the laminated display device, the device will spring back somewhat, and receive a somewhat larger radius of curvature, as is disclosed in FIG. 2e, and as long as the resulting display is not under influence of a force, this bending will remain unchanged. This spring-back effect is due to the stiffness of the films forming the display, and the amount of spring-back is dominantly depending on the thickness and the Young's modulus of the inherent films.

Hence, the display may be said to be constituted by two films or originally non-precurved layers, being held in a curved shape by means of the adhesion between the films. In the corresponding way as described above, this method of manufacturing a curved display is flexible when it comes to the shape and curvature of the resulting display. For example, it is possible to use a force application means that provides a varying bending force over the surface, hence resulting in a display having a varying curvature over its surface. Even if the above described example has a film adhered to the outer curvature of the display, it is also possible to apply the film on the inner curvature of the display. In both cases, the adhesion of the additional layer may be advantageous in that the display layer, in which the display effect is arranged to take place, may be placed in a plane of zero or low stress, depending on the structure of the display device. However, if certain optical components are to be integrated with the additional film, a certain position of the additional film may be necessary. For example, having the additional film on the front side of the display allows integration with optical films such as polarisers, anti-reflection films and so on. It is also possible to adhere additional films both to the inner and outer curvature of the display. An example of such a construction is displayed in FIG. 3e.

The display layer 2, 12 in accordance with the above-described embodiments of this invention may have various configurations. For example, the display layer 2, 12 may be constituted by a liquid crystal cell, essentially comprising a layer of liquid crystal material being sandwiched between a first and a second flexible substrate. According to one alternative, the display layer may be constituted by a polymer light emitting or an organic light emitting display layer. Alternatively, the display layer may be constituted by an E-ink display layer. However, the invention is not limited to the above display layer types, but the display layer may in fact be constituted by any display means, being sufficiently flexible for the desired bending of the entire display. However, it shall be noted that the addition of the additional film 1, 11 to the display layer 2, 12 in the inventive manner shifts the neutral line of the bended display. Thereby, it is possible to arrange so that fragile parts of the display layer end up in a zone of the bended display that experiences near zero tensile or compressive stress or is under compression (i.e. on the inner side of the curvature of the display). By this arrangement, fragile parts of the display layer 2, 12, such as functional brittle layers (e.g. conductive layers, such as ITO or permeation barrier layers, like fused silica or alumina), that predominantly fail when a too large tensile extension is applied on the layer, may end up in the compression zone, thereby improving the mechanical behaviour of the bended display, and also improving the allowed maximal radius of curvature for the construction, as compared to a display layer without an applied additional film.

In both embodiments described above, the additional film 1, 11 may be constituted by an essentially homogeneous layer being applied over essentially the entire surface of the display layer 2, 12. Such an example is shown in cross-section in FIG. 3a.

In case the additional film is pre-stretched, it results in compressive stresses in the display layer. This increase of compressive stresses is advantageous in cases when the display layer comprises brittle or very brittle layers, such as thin glass microsheets. By applying a full, pre-stretched layer at both sides of the display layer, as indicated in FIG. 3e the display layer may be placed under full compressive stresses, while the desired curvature may be obtained by the combination of the pre-stretch of the two additional layers.

Alternatively, the additional film 1, 11 may be constituted by a strip layer, only being applied along the edges of the display layer 2, 12. Examples of such strip layers are disclosed in cross section in FIG. 3b-3c. Other application patterns are also possible. In the case of a strip layer as described above, the strip may either have a equal thickness (FIG. 3c) or have a varying thickness (FIG. 3b, 3d). The application of a strip layer above and near a bend edge of the microsheet as defined above, shifts the neutral line near the bent edge shift in the direction of, or even into the additional strip layer. Hence, the maximal tensile force on the edge upon bending is reduced, or even transferred to a complete compressive load upon downward bending as indicated in FIG. 3b-3d. In this way, as will be described above, a smaller bending radius may be allowed without damaging components of the display layer, being built on the microsheet.

The additional film 1, 11 is in accordance with this invention either a film fully separated from the function of the display layer 2, 12, or a film having a functional relationship with the display layer 2, 12.

In the first-mentioned case, the additional film 1, 11, may be constituted by a polymer film, for example a polymer layer of about 300 mm (E=2.0 GPa) being applied on a 50 μm thick microsheet substrate. Alternatively, the additional film may comprise a fibre-reinforced polymer, or polymer strip, the fibre direction preferably being in the length direction of the strip. Such a strip is preferably applied around the edges of a microsheet as described above. As yet an example, a metal strip may be adhered along the edges of the microsheet. The thickness of the metal film is approximately the same (or slightly lower) than the thickness of the microsheet. As one example, a 30 μm thick steel strip may be applied on a 50 μm thick microsheet. As an alternative, the metal strip may be made by a memory metal. The latter has the advantage that the display may be laminated to the strips of the memory material while flat, and the display is formed by letting the memory material spring back to its memorized shape.

In the second-mentioned case, the additional film 1, 11 may form a functional part of the display layer 2, 12, i.e. may constitute one or more components that are necessary or advantageous for the display function of the display layer 2, 12. In this way, the total thickness of the display device may be reduced. For example, the additional film 1, 11 may be formed to function as a front or a back light, depending on the desired curvature of the display. Alternatively, the additional film 1, 11 may have integrated functionality for functioning as a brightness enhancement film, a retardation layer or a polariser. Other alternatives are also possible, depending on the type of display layer used.

It shall be noted that many variations and modifications of this invention are possible for the man skilled in the art. For example it shall be noted that the invention is not to be limited by the definition of a display layer and an additional film, but may in fact be used for any number of layers of any function in a display device. Moreover it shall be noted that the term flat panel display as used herein shall be construed as a display using a display technology such that the thickness of the display is comparatively small, as opposed to for example a display using cathode ray technology. It shall be noted that the flat panel display device is to be defined as a device exhibiting electro-optical functionality, and the device may be used primarily for display purposes or alternatively, or as a complement, act as a light source for illumination purposes.

It shall also be noted that the term “film” as used herein shall be construed as a flexible layer or film, having a larger extension in two dimensions and a relatively small extension in one dimension. The film or layer is flexible and do not have a pre-defined shape, and may for example be a film of a polymer or glass material.

Further, it shall be noted that in the above description of FIG. 2a-2e, the term “bend” is used to describe the shaping of the display. However, this term is to be construed as including any shaping of the display device resulting in the desired bent shape. For example, the first film may be elastically bent by putting the first film in a mould, having the desired shape. Subsequently, the second film is applied over the first film, while the first film is still in the mould. Thereafter, when the adhesion between the layers has occurred, the mould is removed. As a consequence of the stiffness of the material, as described above, the curved laminated display device will spring back a little, so that the radius of curvature of the display will be larger than for the mould.

Finally, it shall also be noted that a curved display may also be achieved in accordance with the invention by combining the bending and pre-stretching steps described above. In this case, the additional film may for example be pre-stretched, before it is bent in order to adjust the position of the layer with low of zero tensile or compressive stress of the display device. Moreover, several films of layers may be laminated together in accordance with the invention. For example, several additional films may be used in order to improve the mechanical behavior of the display device, or to adjust the position the plane(s) of low or zero stress in the display device.

1. A method of manufacturing a curved flat panel display device, comprising the step of adhering, at least a first film to the surface of a second film, in such a way that the films are held in a curved shape by means of the adhesion between the films.

2. A method as in claim 1, wherein one of said films is a display layer exhibiting display functionality, and the other one of said layerfilms is an additional film.

3. A method as in claim 2, further comprising the step of pre-tensioning said additional film before it is adhered to the surface of said display layer.

4. A method as in claim 3, wherein the step of pre-tensioning said additional film comprises the step of uni-axially stretching said additional film, during the adhering process.

5. A method as claim 2, wherein the step of adhering the films to each other comprises the step of applying a bending force to one of said films, in which position the other film is bent and adhered to a surface of the bent film.

6. A method as in claim 2, wherein said additional film is arranged to be adhered to one of an intended inner or outer side of the curvature of the flat panel display.

7. A method as in claim 2, wherein said adhering of the additional film to the display film is done by means of laminating.

8. A curved flat panel display device, comprising at least a first and a second film, characterised in that the first and second films are adhered to each other, whereby the adhesion between said films is arranged to hold the display device in a curved shape.

9. A display device as in claim 8, wherein the first and second film is an additional film and a display layer, respectively.

10. A curved display device, being manufactured in accordance with claim 1.

11. A display device as in claim 9, wherein said additional film is arranged to cover essentially the entire surface of the display layer.

12. A display device as in claim 9, wherein said additional film is arranged to only partly cover parts of the surface of the display layer.

13. A display device as in claim 9, wherein said additional film is arranged essentially along an edge of the display layer surface.

14. A display device as in claim 9, wherein the additional film has a varying thickness.

15. A display device as in claim 9, wherein the thickness of said additional film is selected to shift a plane of essentially zero tensile or compressive stress of the display device upon bending of the display device to a desired plane of the display device cross section.

16. A display device as in claim 9 wherein said display device is one of an liquid crystal display device, an electrophoretic display device, an e-ink device, a polymer light emitting display device or an organic light emitting display device.

17. A display device as in claim 9 wherein said additional film further is arranged to function as at least one of polariser, a front light, a backlight, a brightness enhancing film, a reflector film, an anti-reflection film or a retardation film.
